(19) United States
(12) Patent Application Publication
(10) Pub. No.: US 2025/0319787 A1
(43) Pub. Date: Oct. 16, 2025

(54) Enhanced EV Charging Battery to Pass-Thru Mode

(71) Applicant: SPEED CHARGE, LLC, Carter Lake, IA (US)

(72) Inventors: Jamshed Nabizada, Fremont, CA (US); Ravi Teja Lavu, Fremont, CA (US)

(21) Appl. No.: 19/006,849

(22) Filed: Dec. 31, 2024

Related U.S. Application Data
(60) Provisional application No. 63/616,729, filed on Dec. 31, 2023.

(51) Int. Cl. B60L 53/62; B60L 53/18; B60L 53/51; B60L 53/63; B60L 53/66

(52) U.S. Cl. CPC B60L 53/62; B60L 53/18; B60L 53/51; B60L 53/63; B60L 53/665; B60L 2250/16

(57) ABSTRACT

A method and system for silently transiting power sources are provided herein. The method, implemented in a controller of a charging system, comprises: initiating a customer session for charging an electric vehicle (EV) to a desired level of charge using a protocol that does not support a switch between power sources within a single charging session; in a first charging session associated with the protocol, transferring electric energy from a first power source to the EV; detecting a trigger condition of the first power source and prior to reaching the desired level of charge at the EV; in response to detecting the trigger condition, in a second charging session of the protocol, transferring electric energy from a second power source to the vehicle; and maintaining the customer session during the first charging session and the second charging session.

### CROSS-REFERENCE TO RELATED APPLICATIONS

This application claims the benefit of U.S. Provisional Application No. 63/616,729, entitled “ENHANCED EV CHARGING BATTERY TO PASS-THRU MODE,” filed on Dec. 31, 2023, the content of which is herein incorporated in its entirety by reference.

### TECHNICAL FIELD

At least one aspect generally relates to improvements to vehicle charging systems, and more particularly to improvements in silently transiting charging sources while maintaining a customer session.

### BACKGROUND

An electric charging system may charge a vehicle using a local energy storage (e.g., a charging battery), an external power source (e.g., an alternate current (AC) grid), or both. There are various protocols for charging electric vehicles, including Combined Charging System (CCS) and CHArge de MOve (CHAdeMO). Different protocols handle charging processes differently, and have different limitations. For example, protocols such as CHAdeMO do not allow the sources of power to switch (e.g., from battery to AC grid) within the same charging session. As a result, providing a partial charge to an EV from a battery and a partial charge from an AC grid requires multiple charging sessions.

### SUMMARY

The methods and systems disclosed herein solve the problem of seamlessly transitioning between charging sources when the charging protocol requires a charging session be disrupted in such cases. The transitions between charging sessions are also referred to below as “silent” because the charging session does not notify the customer of the change in charging sessions and instead provides the multiple charging sessions within a single uninterrupted customer session. In the discussion below, the terms “user” and “customer” are used interchangeably.

The customer session can be delimited for example by approval of the form of payment and a confirmation of the amount of payment. Thus, the customer session may begin with an initial notification via a user interface of the charging session or the customer's device such as a smartphone or smartwatch for example, that a transfer of electric energy has begun, and end with a final notification that the charge of the EV is complete. To the extent that the charging session provides intermediate notifications via the user interface, these notification pertain to the same customer session and generally do not require additional customer actions.

In some cases, the customer session is delimited by the customer physically connecting (engaging) the charging cable to the EV and disconnecting (disengaging) the charging cable. As discussed below, the charging session of this disclosure can provide multiple charging sessions between these two events, such as a battery charging session followed by an AC pass-thru charging session, without requiring that the user disconnect and reconnect the cable.

An example embodiment of the techniques of this disclosure is a method for providing silent transition of charging sources is provided. The method can be implemented in a controller of a charging system and comprises initiating a customer session for charging an electric vehicle (EV) to a desired level of charge using a protocol that does not support a switch between power sources within a single charging session; in a first charging session associated with the protocol, transferring electric energy from a first power source to the EV; detecting a trigger condition of the first power source and prior to reaching the desired level of charge at the EV; in response to detecting the trigger condition, in a second charging session of the protocol, transferring electric energy from a second power source to the vehicle; and maintaining the customer session during the first charging session and the second charging session.

Another example embodiment of these techniques is charging system configured to provide silent transition of charging sources., The charging system comprises a first power source; a connection to a second power source; and a controller configured to: initiate a customer session for charging an electric vehicle (EV) to a desired level of charge using a protocol that does not support a switch between power sources within a single charging session; in a first charging session associated with the protocol, transfer electric energy from the first power source to the EV; detect a trigger condition of the first power source and prior to reaching the desired level of charge at the EV; in response to detecting the trigger condition, in a second charging session of the protocol, transfer electric energy from the second power source to the EV, and maintain the customer session during the first charging session and the second charging session.

### BRIEF DESCRIPTION OF THE DRAWINGS

FIG. 1 illustrates a block diagram of an example of an electric vehicle charging system configured in accordance with certain aspects disclosed herein.

FIG. 2A illustrates a signal diagram of an example process of silently transiting charging sources in accordance with certain aspects disclosed herein.

FIG. 2B illustrates a signal diagram following the signal diagram of FIG. 2A.

FIG. 2C illustrates a signal diagram following the signal diagram of FIG. 2B.

FIG. 3 illustrates a flow diagram of an example process of silently transiting charging sources in accordance with certain aspects disclosed herein.

### DETAILED DESCRIPTION

The techniques disclosed herein generally relate to seamlessly transitioning between charging sources when the charging protocol requires a charging session be disrupted in such transitions. There are various scenarios where a charging system needs to change power sources for charging an electric vehicle (EV) before the EV reaches a desired level of charge. For example, the charging system may first charge the EV using a local power storage in the charging system (e.g., a charging battery). The local power storage may be unable to provide electric energy when it is depleted to a low state of charge (SoC). In such cases, the charging system may need to switch the power source from the lower power storage to another source. The other source may be an external power source (e.g., an AC grid) or an external power storage outside of the charging system (e.g., a charging battery electrically connected to the charging system).

As another example, the charging system may first charge the EV with an external power source (e.g., an AC grid). However, due to a disruption in the availability of the AC grid, or because of a chance in fees associated with the AC grid due the time of day for example, the charging station may determine to dynamically switch the power source from the external power source to a local power storage. As yet another example, the charging system may first charge the EV with both an external power source and a local power storage. The charging system may need to transit the power source to either the external power source or a local power storage for similar reasons described above, respectively.

Changing power sources for charging an EV typically involves a significant change in the charging power. Although the CCS protocol can handle such a change without disrupting a charging session, a protocol such as CHAdeMO protocol requires termination of the current charging session and starting a new charging session for the new power source. If the charging station accordingly terminates the customer session and starts a new customer session, the customer may need to agree to the customer session, re-enter the form of payment, and possibly physically disconnect and reconnect the charging cable. In any case, notifying the customer of the change in charging sessions requires additional customer activity, which is undesirable.

The techniques disclosed herein provide a method and system for seamlessly transiting charging power sources when the charging process uses a protocol that does not support a silent transition by itself, such as the CHAdeMO protocol. The techniques disclosed herein leverage a feature of the CHAdeMO protocol, that is, the CHAdeMO protocol does not require a charging connector (e.g., a charging cable) to be disengaged and re-engaged to start a new charging session. This feature allows the method and system disclosed herein to silently terminating a charging session that uses a first power source, and silently starting a new charging session that uses a second power source. In this way, unknown to the customer, the method and system disclosed herein silently transits power sources even though the charging protocol by itself does not provide such a silent transition. Therefore, the techniques disclosed herein provide a unique technical solution to a technical problem in certain charging protocols (e.g., CHAdeMO), and generally improves a customer's charging experience.

### Example Charging System

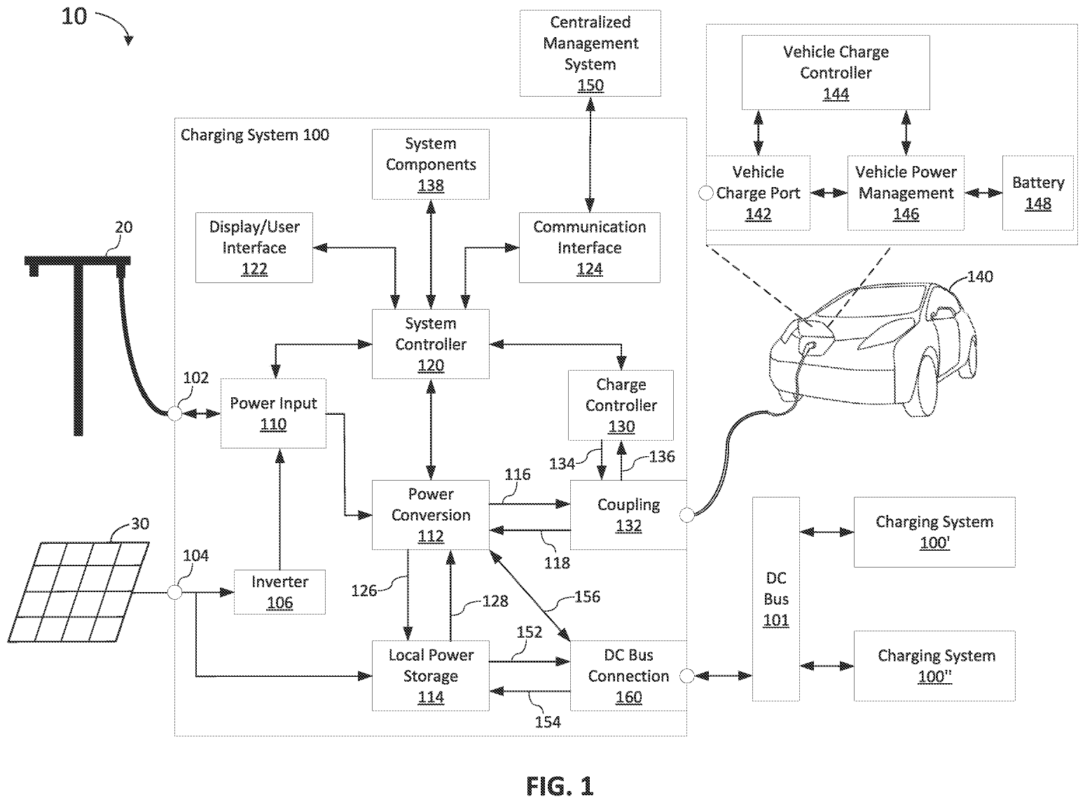

FIG. 1 illustrates a block diagram of an example charging site 10. The charging site 10 includes one or more EV charging systems 100, 100′, and 100″ configured in accordance with certain aspects disclosed herein.

The EV charging system 100 is configured to receive electric energy from a power source (e.g., an external power source 20, a local power generator 30, etc.) via an input port 102 or 104 in order to charge a local power storage 114 (e.g., one or more charging batteries), from which the EV charging system 100 provides a charging current to a vehicle 140 in order to charge a vehicle battery 148 of the vehicle 140. Such charge is provided through a vehicle coupling 132, which may comprise a charging cable utilizing one or more standard connector types (e.g., Combined Charging System (CCS) or Charge de Move (CHAdeMO) connectors). In addition to being connected to one or more power sources via the input ports 102 or 104, the EV charging system 100 includes a DC bus connection 160 to the DC bus 101 at the charging site 10. Through the DC bus connection 160, the EV charging system 100 is configured to transfer DC power to one or more additional EV charging systems 100′ or 100″ and to receive DC power from such additional EV charging systems 100′ or 100″, as controlled by a system controller 120 of the EV charging system 100. Although the illustrated EV charging system 100 is illustrated as communicating with a centralized management system 150, alternative embodiments of the EV charging system 100 need not be configured for such external communication. Although the illustrated EV charging system 100 is illustrated as connecting to a local power generator 30, alternative embodiments of the EV charging system 100 need not be configured for such connection. Such alternative embodiments may omit the local power generator 30, the input port 104, the inverter 106, and the power conditioning 108. Additional or alternative components and functionality may be included in further alternative embodiments of charging systems.

The EV charging system 100 includes a power input module 110 having one or more circuits configurable to transform, condition, or otherwise modify power received from an input port 102 or 104 to provide power to a power conversion module 112. The input power received at input ports 102 or 104 may be received from an external power source 20 (e.g., an AC grid), a local power generator 30 (e.g., a solar panel or a wind turbine), or any other power source. In some embodiments, input AC power is received at an AC input port 102, while input DC power is received at a DC input port 104 (e.g., from photovoltaic cells or other types of DC power sources). The DC input port 104 may be connected to one or more of an inverter module 106 for the input DC power. In further embodiments, DC current received via DC input port 104 is converted to an AC current by an inverter module 106, and the AC current is then provided to power input module 110. The power input module 110 may combine AC or DC current received from multiple sources. Similarly, the power input module 110 may direct AC or DC current received from multiple sources to individual circuits or sections of the power conversion module 112. In some embodiments, the power input module 110 may include a rectifier to convert AC current received at an input port 102 or 104 into DC current to be provided to the power conversion module 112.

The power conversion module 112 includes some combination of one or more AC-to-DC, DC-to-DC, and/or DC-to-AC converters for efficient conversion of AC or DC input power received from a power utility or other source at input port 102 or 104 via the power input module 110 to a DC energy storage current 126 provided to the local power storage 114, which stores the power until needed to provide a charging current 116 to a vehicle 140. In some embodiments, the power conversion module 112 includes an AC-to-DC conversion circuit that generates a DC energy storage current 126 that is provided to a local power storage 114. Alternatively, the power input module 110 may include an AC-to-DC conversion circuit to generate a DC current from an input AC electric energy. In further embodiments, the local power storage 114 includes high-capacity batteries that have a storage capacity greater than a multiple of the storage capacity in the EVs to be charged (e.g., three times, five times, or ten times an expected vehicle battery capacity). The storage capacity of the local power storage 114 may be configured based on the expected average charge per charging event, which may depend upon factors such as the types of vehicles charged, the depletion level of the vehicle batteries when charging starts, and the duration of each charging event.

In some embodiments, the power conversion module 112 may include one or more DC-to-DC conversion circuits that receive DC current 128 at a first voltage level from the local power storage 114 and drive a charging current 116 to a vehicle 140 through a vehicle coupling 132 to supply a vehicle 140 with the charging current 116 via a vehicle charge port 142. The vehicle coupling 132 serves as an electrical interconnect between the EV charging system 100 and the vehicle 140. In various embodiments, such vehicle coupling 132 comprises a charging head and/or a charging cable. For example, the vehicle coupling 132 may comprise a charging cable having a standard-compliant plug for connection with a vehicle charge port 142 of vehicles 140. The vehicle coupling 132 may include both a power connection for carrying the charging current 116 and a communication connection for carrying electronic communication between the charge controller 130 and the vehicle 140. In some embodiments, the EV charging system 100 may comprise multiple vehicle couplings 132, and the power conversion module 112 may include a corresponding number of DC-to-DC conversion circuits specific to each of the multiple couplings. According to some embodiments, the power conversion module 112 may be further configured to receive a reverse current 118 from a vehicle 140 via the vehicle coupling 132, which reverse current 118 may be used to provide a DC energy storage current 126 to add energy to the local power storage 114. In some examples, the power conversion module 112 includes one or more inverters that convert the DC current 128 to an AC current that can be provided as the charging current 116.

A charge controller 130 controls the charging current 116 and/or reverse current 118 through each vehicle coupling 132. To control charging or discharging of the vehicle 140, the charge controller 130 comprises one or more logic circuits (e.g., general or special-purpose processors) configured to execute charging control logic to manage charging sessions with vehicle 140. Thus, the charge controller 130 is configured to communicate with the system controller 120 to control the power conversion module 112 to provide the charging current 116 to the vehicle 140 or to receive the reverse current 118 from the vehicle 140 via the vehicle coupling 132. In some instances, the charge controller 130 may include power control circuits that further modify or control the voltage level of the charging current 116 passed through the vehicle coupling 132 to the vehicle 140. The charge controller 130 also communicates via the vehicle coupling 132 with a vehicle charge controller 144 within the vehicle 140 to manage vehicle charging. Thus, the charge controller 130 communicates with the vehicle charge controller 144 to establish, control, and terminate charging sessions according to EV charging protocols (e.g., CCS or CHAdeMO). The charge controller 130 may be communicatively connected with the vehicle coupling 132 to provide output signals 134 to the vehicle charge controller 144 and to receive input signals 136 from the vehicle charge controller 144.

A system controller 120 is configured to control operations of the EV charging system 100 by implementing control logic using one or more general or special-purpose processors. The system controller 120 is configured to monitor and control power levels received by the power input module 110, power levels output through the charging current 116, energy levels in the local power storage 114, and charge received from or output to the DC bus 101 via the DC bus connection 160. The system controller 120 is further configured to communicate with and control each of the one or more charge controllers 130, as well as controlling the power conversion module 112. For example, the system controller 120 is configured to control the power conversion module 112 and the charge controller to supply a charging current 116 to the vehicle coupling 132 in response to instructions from the charge controller 130. As discussed further herein, the system controller 120 is also configured to (either separately or in coordination with the centralized management system 150) control the power source for charging the EV 140 in different charging sessions, such as by transmitting instructions to the power input 110 or the power conversion 112 to control the power source to be used to charge the EV 140. The system controller 120 is also configured to maintain customer sessions during the switch between power sources.

The system controller 120 is also configured to communicate with other various system components 138 of the EV charging system 100 (e.g., other controllers or sensors coupled to the local power storage 114 or other components of the EV charging system 100) in order to receive operating data and to control operation of the system via operation of such system components 138. For example, the system controller 120 may monitor temperatures within the EV charging system 100 using the system components 138 and may be further configured to mitigate increases in temperature through active cooling or power reductions using the same or different system components 138. Likewise, the system controller 120 communicates with a user interface module 122 (e.g., a touchscreen display) and a communication interface module 124 (e.g., a network interface controller) to provide information and receive control commands. Each communication interface module 124 may be configured to send and receive electronic messages via wired or wireless data connections, which may include portions of one or more digital communication networks.

The system controller 120 is configured to communicate with the components of the EV charging system 100, including power input module 110, power conversion module 112, the user interface module 122, the communication interface module 124, the charge controller 130, and the system components 138 over one or more data communication links. The system controller 120 may also be configured to communicate with external devices, including a vehicle 140 via the vehicle coupling 132, one or more additional EV charging systems 100′ and 100″ via the centralized management system 150, one or more external batteries 30, or a site meter 22. The system controller 120 may manage, implement or support one or more data communication protocols used to control communication over the various communication links, including wireless communication or communication via a local router 42. The data communication protocols may be defined by industry standards bodies or may be proprietary protocols.

The user interface module 122 is configured to present information related to the operation of the EV charging system 100 to a user and to receive user input. The user interface module 122 may include or be coupled to a display with capabilities that reflect intended use of the EV charging system 100. In one example, a touchscreen may be provided to present details of charging status and user instructions, including instructions describing the method of connecting and disconnecting a vehicle 140. The user interface module 122 may include or be coupled to a touchscreen that interacts with the system controller 120 to provide additional information or advertising. The system controller 120 may include or be coupled to a wireless communication interface that can be used to deliver a wide variety of content to users of the EV charging system 100, including advertisements, news, point-of-sale content for products/services that can be purchased through the user interface module 122. The display system may be customized to match commercial branding of the operator, to accommodate language options and for other purposes. The user interface module 122 may include or be connected to various input components, including touchscreen displays, physical input mechanisms, identity card readers, touchless credit card readers, and other components that interact through direct connections or wireless communications. The user interface module 122 may further support user authentication protocols and may include or be coupled to biometric input devices such as fingerprint scanners, iris scanners, facial recognition systems and the like.

In some embodiments, the local power storage 114 is provisioned with a large battery pack, and the system controller 120 executes software to manage input received from a power source based on trigger conditions. The software may be further configured to manage power source transitions and customer session maintenance, as will be described below in detail.

In some embodiments, the EV charging system 100 may be configured with two or more vehicle couplings 132 to enable concurrent charging of multiple vehicles 140. The system controller 120 may be configured by a user via the user interface module 122 to support multiple modes of operation and may define procedures for charge transfer or power distribution that preserve energy levels in the local power storage 114 when multiple vehicles 140 are being concurrently charged. Charge transfers may be used to transfer power from EV charging systems 100 that have available power or are not being used to charge a vehicle 140 to EV charging systems 100 that are charging one or more vehicles 140. Distribution of power may be configured to enable fast charging of one or more vehicles 140 at the expense of other vehicles 140. In this regard, the vehicle couplings 132 may be prioritized or the system controller 120 may be capable of identifying and prioritizing connected vehicles 140. In some instances, the system controller 120 may be configured to automatically control the respective charge controllers 130 to split available power between two vehicles 140 after the second vehicle 140 is connected. The available power may be evenly split between two vehicles 140 or may be split according to priorities or capabilities. In some examples, the system controller 120 may conduct arbitration or negotiation between connected vehicles 140 to determine a split of charging capacity. A vehicle 140 may request a charging power level at any given moment based on temperature, battery charge level, and other characteristics of the vehicle 140 and its environment and to achieve maximum charge rate and minimum charging time for the current circumstances.

As illustrated, a vehicle 140 may be charged by connecting the vehicle 140 to the EV charging system 100 via a vehicle coupling 132. This may include plugging a charging cable of the EV charging system 100 into a vehicle charge port 142 of the vehicle 140. The vehicle charge port 142 is configured to receive the charging current 116 through the vehicle coupling 132 and provide such received current to a vehicle power management module 146. The vehicle charge port 142 is further configured to provide an electronic communication connection between the vehicle coupling 132 and a vehicle charge controller 144, which controls charging of the vehicle 140. The vehicle power management module 146 is controlled by the vehicle charge controller 144 to provide power to each of one or more batteries 148 of the vehicle 140 in order to charge such battery 148. In some instances, the vehicle charge port 142 includes a locking mechanism to engage and retain a portion of the vehicle coupling 132 in place during charging sessions. For example, for safety reasons, the vehicle charge controller 144 may control a locking mechanism of the vehicle charge port 142 to lock a plug of a charging cable in the vehicle charge port 142 while a charging session is active.

It should be understood that the charging system 100 may include additional, fewer, and/or alternate components, and may be configured to perform additional, fewer, or alternate actions, including components/actions described herein.

### Example Signal Diagram

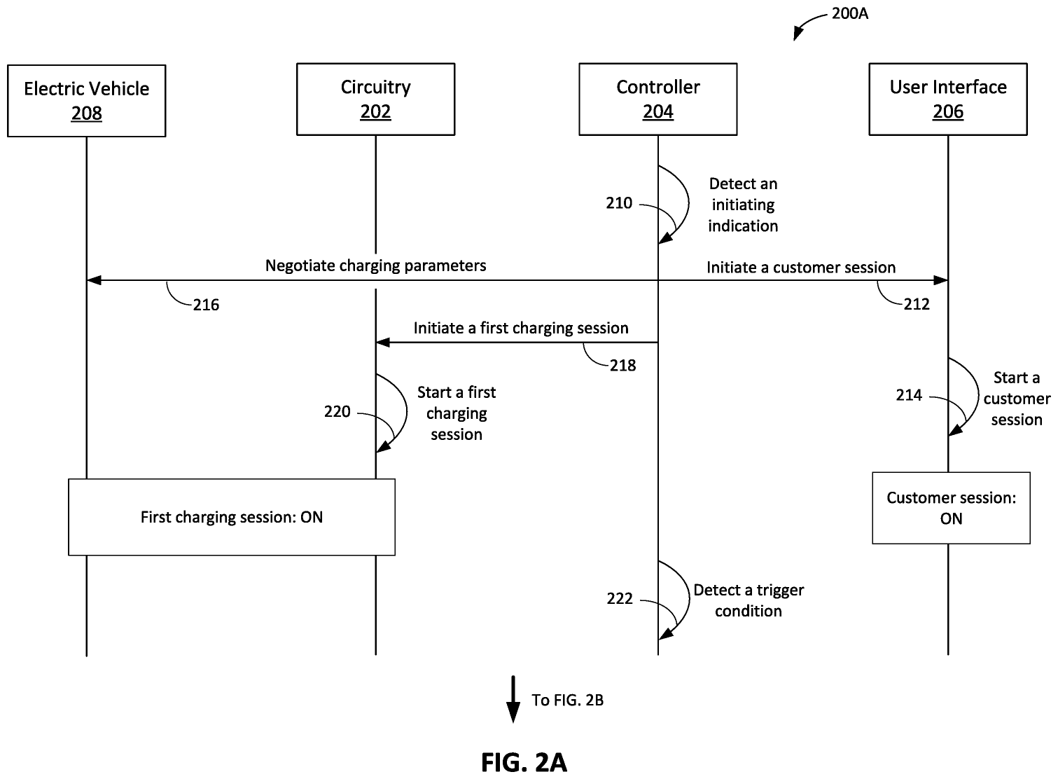

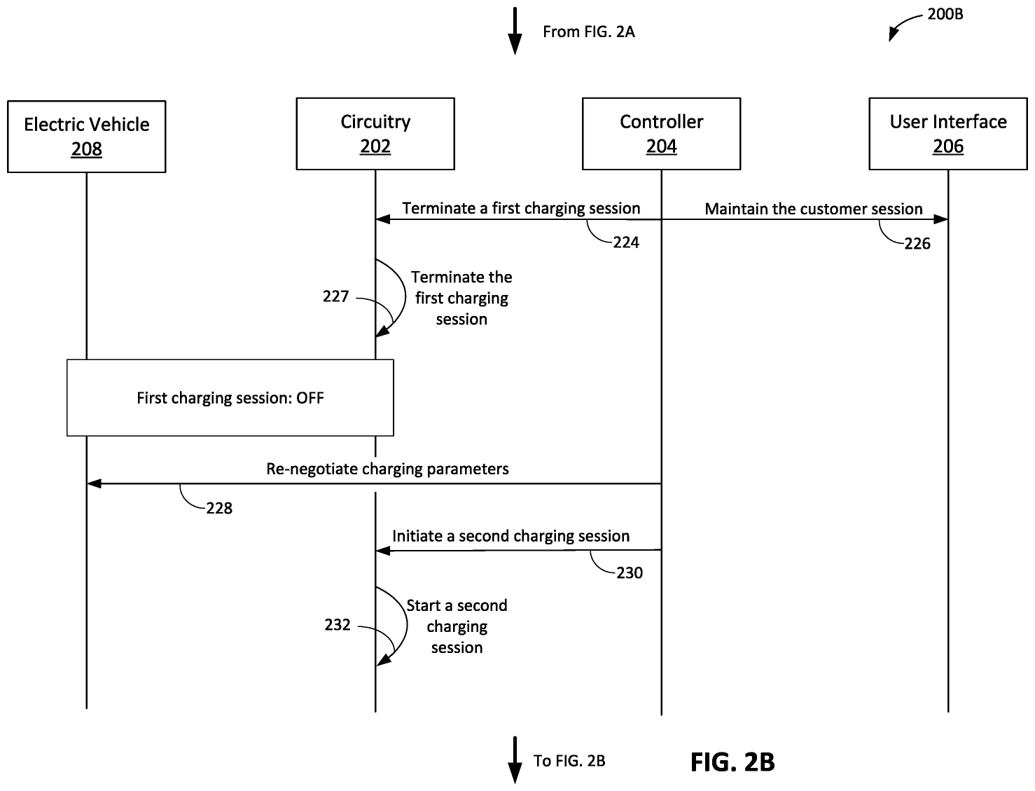

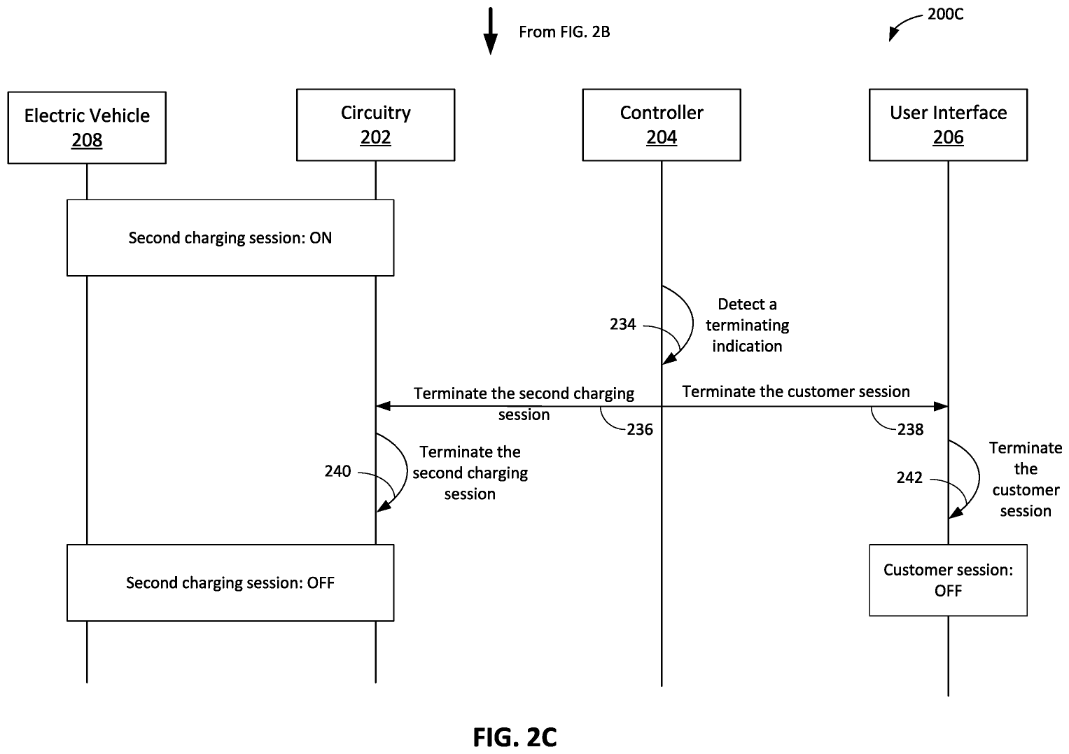

FIG. 2A illustrates a signal diagram of an example process 200A of silently transiting charging sources in accordance with certain aspects disclosed herein.

The example process 200A begins when a controller 204 (such as the system controller 120) detects (210) an initiating indication for a charging process using a protocol that does not support a switch between power sources within a single charging session, such as CHAdeMO. For example, an initiating indication is a user input to a user interface 206 (such as the user interface 122) that indicates a start of a charging process. As another example, an initiating indication is a user making an initial financial payment for a charging process. As yet another example, an initiating indication is a charging cable being connected to a vehicle battery of an EV 208 (such as the EV 140).

Responsive to detecting (210) the initiating indication, the controller 204 initiates (212) a customer session. In some embodiments, the controller 204 initiates (212) the customer session by transmitting instructions to a user interface 206 (such as the user interface 122). The user interface may start (214) a customer session by indicating that a charging process begins. In such embodiments, a customer session corresponds a set of indications of the user interface 206. That is, the user interface 206 may terminate the customer session by indicating that a charging process is terminated. Additionally or alternatively, a customer session may correspond to a single cable engagement event and a single cable disengagement event. Additionally or alternatively, a customer session may correspond to a single financial transaction. The financial transaction (e.g., the payment amount) is based on the electric energy transferred in the entire charging process, including the first charging session and the second charging session.

Responsive to detecting (210) the initiating indication, the controller 204 also negotiates (216) charging parameters with the EV 208. For example, the controller 204 may receive signals indicating a current level of charge of the vehicle battery, a maximum level of charge of the vehicle battery, and other necessary information. The controller 204 may determine a current for charging based on the signals and transmit signals indicating the current to the EV 208. Once the controller 204 and the EV 208 agree on the charging parameters, the controller 204 initiates (218) a first charging session.

To initiate (214) the first charging session, the controller 204 transmits instructions to a circuitry 202 (such as the power input 110, the power conversion 112, or other components of the charging system 100) to cause the circuitry to start (220) the first charging session. In the first charging session, the circuitry 202 transfers electric energy from a first power source to the vehicle battery. In an example CHAdeMO implementation, the controller sets the charge sequence signal 1 and the charge sequence signal 2 corresponding to the first power source to ON, for the corresponding pins. More generally, the controller 204 and/or the circuitry 202 can provide signals via any suitable number of signals via any number of pins, depending on the specific implementation of the protocol and/or of the associated physical connector.

In some embodiments, the first power source is a local power storage (such as the local power storage 114) disposed in the charging system. Correspondingly, the controller 204 may set a charge sequence signal corresponding to the local power storage to be ON. In response, for example, the power conversion 112 receives electric energy from the local power storage 114. The controller 204 may further set a charge sequence signal (e.g., charge sequence signal 1 and charge sequence signal 2) corresponding to other power sources to be OFF. In response, for example, the power conversion 122 may refrain from receiving electric energy from the power input 110 or the DC bus connection 160. In other embodiments, the first power source is an external power source (such as the external power source 20). In yet other embodiments, the first power source is a local power generator (such as the local power generator 30). In yet other embodiments, the first power source is an external power storage (such as a local power storage in the charging system 100′ or 100″) outside of the charging system. In yet other embodiments, the first power source is a combination of one or more power sources described above.

While the first charging session is ongoing and before detecting a terminating indication (described below), the controller may detect (222) a trigger condition for terminating the first charging session. In the embodiments where the first power source includes a local power storage or an external power storage, the trigger condition may be the local power storage or the external power storage has been depleted to a low condition-of-charge, such as the remaining charge is less than 10% of its maximum charge capacity. In the embodiments where the first power source includes the external power source, the trigger condition may be an electricity fee of the external power source is high at the time of the day. In the embodiments where the first power source includes the local power generator, the trigger condition may be the power generated by the local power generator is low or unstable.

Turning to FIG. 2B, upon detecting (222) the trigger condition, the controller 204 transmits instructions to the circuitry 202 to terminate (224) the first charging session. The circuitry 202, upon receiving the instructions for terminating the first charging session, terminates (227) the first charging session by stopping transferring electric energy from the first power source to the vehicle battery. To this end, the controller 204 may set a charge sequence signal corresponding to the first power source to be OFF. Correspondingly, the power conversion 122 may refrain from receiving electric energy from the first power source.

Upon detecting (222) the trigger condition, the controller 204 may also maintain (226) the customer session. In some embodiments, to maintain (226) the customer session, the controller 204 may transmit instructions to the user interface 206 to cause the user interface to refrain from indicating that the first charging session has been terminated. Additionally or alternatively, the controller 204 may transmit instructions to the circuitry 202 to cause the circuitry to refrain from disengaging a charging cable between the charging system and the EV 208.

The controller 204 then re-negotiates (228) charging parameters with the EV 208. For example, based on features of the power source to be used in a second charging session (i.e., the second power source), the controller 204 and the vehicle battery may agree on a new set of charging parameters. In some embodiment, at least one parameter of the new set of charging parameters is different from the charging parameters used in the first session.

Upon agreeing on the charging parameters, the controller 204 transmits instructions to the circuitry 202 to initiate (230) the second charging session. In response, the circuitry 202 starts (232) the second charging session by transferring electric energy from a second power source to the vehicle battery. To this end, the controller may set a charge sequence signal corresponding to the second power source to be ON.

The second power source may be any power source described above that is different from the first power source. For example, in the embodiments where the first power source is the local power storage, the second power source may be the external power source, the local power generator, or the external power storage. In the example where the second power source is the external power source, the controller 204 sets a charge sequence signal corresponding to the external power source to be ON. In response, for example, the power conversion 112 receives electric energy from the external power source 20 via the power input 110. In response, for example, the power conversion 122 may refrain from receiving electric energy from the power input 110 or the DC bus connection 160. As another example, in the embodiments where the first power source is the external power source, the second power source may be the local power storage, the local power generator, or the external power storage. As yet another example, in the embodiments where the first power source is a combination of the external power source and the local power storage, the second power source may be the external power source alone.

Turning to FIG. 2C, while the second charging session is ongoing, the controller 204 may detect (234) a terminating condition. The terminating condition may be the vehicle battery has reached a desired level of charge, such as a maximum level of charge of the vehicle battery or a charge level selected by the user via the user interface 206. Additionally or alternatively, the terminating condition may be a user input indicating that the user wishes to terminating the charging process. For example, the user may interact with the user interface 206 to indicate the wish of terminating the charging process. Additionally or alternatively, the terminating condition may be the charging cable is physically disconnected with the vehicle battery, e.g., by accident.

Upon the controller 204 detecting (234) the terminating condition, the controller 204 transmits instructions to the circuitry 202 to terminate (236) the second charging session. In response, the circuitry 202 terminates (240) the second charging session 240 by stopping transferring electric energy from the second power source to the vehicle battery. To this end, the controller 204 may set a charge sequence signal corresponding to the second power source to be OFF. Correspondingly, the power conversion 122 may refrain from receiving electric energy from the second power source.

Upon the controller 204 detecting (234) the terminating condition, the controller 204 also terminates (238) customer session. In some embodiments, to terminate the customer session, the controller 204 transmits instructions to the user interface 206 to cause the user interface to terminate (242) the customer session by indicating that the charging process has been terminated. Additionally or alternatively, to terminate the customer session, the controller 204 transmits instructions to the circuitry 202 to cause the charging cable to be disengaged from the vehicle battery.

It should be understood that not all steps of the signal diagrams 200A and 200B are required to be performed. The blocks do not need to be performed in the particular order as depicted in the signal diagrams 200A and 200B. It should be also understood that additional and/or alternative steps may be performed.

### Example Block Diagram

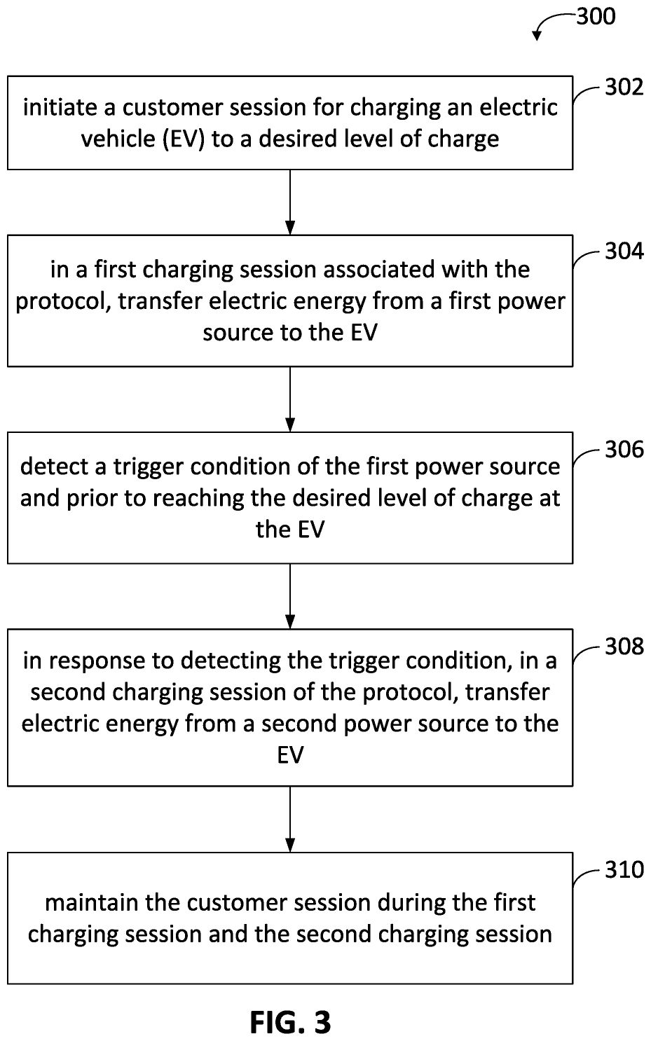

FIG. 3 illustrates a flow diagram 300 of an example process of silently transiting charging sources in accordance with certain aspects disclosed herein.

At block 302, a controller (such as the system controller 120 or the centralized management system 150) of a charging system (such as the charging system 100), initiate a customer session for charging an electric vehicle (EV) to a desired level of charge as describe above with respect to steps 210-214. The charging process uses a protocol that does not support a switch between power sources within a single charging session. In some embodiments, the protocol supports starting a new charging session without disengaging and re-engaging an electric cable between the charging station and the EV. In some embodiments, the protocol is CHAdeMO.

In some embodiments, to initiate the customer session, the controller causes a user interface to provide, via a user interface, a notification that the customer session has started.

At block 304, in a first charging session associated with the protocol, the controller causes the charging system to transfer electric energy from a first power source to the EV, as described above with respect to steps 216-220. In some embodiments, the first power source is a local power storage disposed in the charging system, and the second power source is an external power source disposed outside the charging system. In some embodiments, to cause the charging system to transfer electric energy from a first power source to the EV, the controller sets a charge sequence signal corresponding to the power source(s) used in the first charging session to be ON.

At block 306, prior to reaching the desired level of charge at the EV, the controller detects a trigger condition of the first power source, as described above with respect to step 220.

At block 308, in response to detecting the trigger condition, in a second charging session of the protocol, the controller causes the charging system to transfer electric energy from a second power source to the EV, as described above with respect to steps 228-232. In some embodiments, to cause the charging system to transfer electric energy from a second power source to the EV, the controller sets a charge sequence signal corresponding to the power source(s) used in the second charging session to be ON.

In some embodiments, prior to transferring electric energy in the second session, the controller terminates the first session as described above with respect to steps 224 and 227. In some embodiments, to terminate the first charging session, the controller sets a charge sequence signal corresponding to the power source(s) used in the first charging session to be OFF.

At block 310, the controller maintains the customer session during the first charging session and the second charging session, as described above with respect to step 226. In some embodiments, to maintaining the customer session, the controller causes the user interface to refrain from providing notifications related to the second charging session.

In some embodiments, the customer session corresponds to a single cable engagement event and a single cable disengagement event. In such embodiments, the electric vehicle remains connected to the charging session when the charging session transitions from the first charging session to the second charging session. The controller prevents a disengagement of an electric cable between the charging system and the EV after ending of the first charging session and prior to ending of the second charging session.

In some embodiments, the customer session corresponds to a single financial transaction. In such embodiments, the single financial transaction is based on the electric energy transferred during the first charging session and the second charging session.

In some embodiments, the controller terminates the second charging session and the customer session upon detecting a terminating indication as described above with respect to steps 234-242. In some embodiments, to terminate the second charging session, the controller sets a charge sequence signal corresponding to the power source(s) used in the second charging session to be OFF.

It should be understood that not all blocks of the flow diagram 300 are required to be performed. The blocks do not need to be performed in the particular order as depicted in the flow diagram 300. For example, block 310 may be performed at the same time of block 308. It should be also understood that additional and/or alternative steps may be performed.

### Additional Considerations

Although the preceding text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______ ’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. No claim element is to be construed as a means plus function unless the element is expressly recited using the phrase “means for.”

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Unless specifically stated otherwise, the term “some” refers to one or more. Likewise, use of the “a” or “an” are employed to describe elements and components of the embodiments herein. This is done merely for convenience and to give a general sense of the description. This description, and the claims that follow, should be read to include one or at least one and the singular also includes the plural unless the context clearly indicates otherwise.

Upon reading this disclosure, those of skill in the art will appreciate still additional alternative structural and functional designs for the systems and a methods disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method implemented in a controller of a charging system, the method comprising:
initiating a customer session for charging an electric vehicle (EV) to a desired level of charge using a protocol that does not support a switch between power sources within a single charging session;
in a first charging session associated with the protocol, transferring electric energy from a first power source to the EV;
detecting a trigger condition of the first power source, prior to reaching the desired level of charge at the EV;
in response to the detecting of the trigger condition, in a second charging session of the protocol, transferring electric energy from a second power source to the vehicle; and
maintaining the customer session during the first charging session and the second charging session.

2. The method of claim 1, wherein:
the first power source is a local power storage disposed in the charging system; and
the second power source is an external power source disposed outside the charging system.

3. The method of claim 1, wherein:
the initiating of the customer session includes providing, via a user interface, a notification that the customer session has started;
the method further comprising:
providing, via the user interface and after the second charging session has completed, a notification that the customer session has ended.

4. The method of claim 3, wherein the maintaining of the customer session includes refraining from providing notifications related to the second charging session via the user interface.

5. The method of claim 1, wherein:
the customer session corresponds to a single cable engagement event and a single cable disengagement event, wherein the EV remains connected to the charging session when the charging session transitions from the first charging session to the second charging session.

6. The method of claim 1, wherein:
the customer session corresponds to a single financial transaction, wherein the single financial transaction is based on the electric energy transferred during the first charging session and the second charging session.

7. The method of claim 1, wherein the protocol supports starting a new charging session without disengaging and re-engaging an electric cable between the charging system and the EV.

8. The method of claim 1, wherein the maintaining of the customer session includes preventing a disengagement of an electric cable between the charging system and the EV after ending of the first charging session and prior to ending of the second charging session.

9. The method of claim 1, wherein the protocol is a CHArge de MOve (CHAdeMO) protocol.

10. The method of claim 1, wherein:
the transferring of electric energy in each of the first charging session and the second charging includes:
setting a charge sequence signal 1 and a charge sequence signal 2 to ON to start a corresponding session, the charge sequence signal 1 corresponding to a first connector pin and the charge sequence signal 2 corresponding to a second connector pin, and
setting the charge sequence signal 1 and a charge sequence signal 2 to OFF to end the corresponding charging session.

11. A charging station, comprising:
a first power source;
a connection to a second power source; and
a controller configured to:
initiate a customer session for charging an electric vehicle (EV) to a desired level of charge using a protocol that does not support a switch between power sources within a single charging session;
in a first charging session associated with the protocol, transfer electric energy from the first power source to the EV;
detect a trigger condition of the first power source and prior to reaching the desired level of charge at the EV;
in response to detecting the trigger condition, in a second charging session of the protocol, transfer electric energy from the second power source to the EV, and
maintain the customer session during the first charging session and the second charging session.

12. The charging system of claim 11, wherein:
the first power source is a local power storage disposed in the charging system; and
the second power source is an external power source disposed outside the charging system.

13. The charging system of claim 11, further comprising:
a user interface;
wherein the initiating of the customer session includes providing, via a user interface, a notification that the customer session has started, and
the controller is further configured to provide, via the user interface and after the second charging session has completed, a notification that the customer session has ended.

14. The charging system of claim 13, wherein the maintaining of the customer session includes refraining from providing notifications related to the second charging session via the user interface.

15. The charging system of claim 11, wherein:
the customer session corresponds to a single cable engagement event and a single cable disengagement event, wherein the EV remains connected to the charging session when the charging session transitions from the first charging session to the second charging session.

16. The charging system of claim 11, wherein:
the customer session corresponds to a single financial transaction, wherein the single financial transaction is based on the electric energy transferred during the first charging session and the second charging session.

17. The charging system of claim 11, wherein:
the protocol supports starting a new charging session without disengaging and re-engaging an electric cable between the charging system and the EV.

18. The charging system of claim 11, wherein:
the maintaining of the customer session includes preventing a disengagement of an electric cable between the charging system and the EV after ending of the first charging session and prior to ending of the second charging session.

19. The charging system of claim 11, wherein the protocol is a CHArge de MOve (CHAdeMO) protocol.

20. The charging system of claim 11, wherein:
the transferring of electric energy in each of the first charging session and the second charging includes:
setting a charge sequence signal 1 and a charge sequence signal 2 to ON to start a corresponding session, the charge sequence signal 1 corresponding to a first connector pin and the charge sequence signal 2 corresponding to a second connector pin, and
setting the charge sequence signal 1 and a charge sequence signal 2 to OFF to end the corresponding charging session.
